(19) United States
(12) Patent Application Publication
(10) Pub. No.: US 2025/0158327 A1
(43) Pub. Date: May 15, 2025

(54) LEVER-EQUIPPED CONNECTOR AND CONNECTOR ASSEMBLY

(71) Applicant: SUMITOMO WIRING SYSTEMS, LTD., Mie (JP)

(72) Inventor: Hiroki YOSHIHARA, Mie (JP)

(21) Appl. No.: 18/938,760

(22) Filed: Nov. 6, 2024

(30) Foreign Application Priority Data
Nov. 14, 2023 (JP) 2023-193696

(51) Int. Cl. H01R 13/629

(52) U.S. Cl. CPC H01R 13/62938; H01R 13/6295

(57) ABSTRACT

A lever-equipped connector includes a detecting member attached to a lever to allow a movement from a standby position to a detection position only when the lever is located at a connection position. The detecting member includes a head portion arranged to be exposed from the lever for operation of the detecting member and a leg portion formed to extend from the head portion to be inserted into an insertion recess of a connector housing when the lever is located at the connection position. A deformation suppressing portion for suppressing deformation of the leg portion in an opening direction when the detecting member is pushed from above with the lever located at the pre-connection position is provided between the connector housing and the leg portion.

### CROSS-REFERENCE TO RELATED APPLICATIONS

This application is based on and claims priority from Japanese Patent Application No. 2023-193696, filed on Nov. 14, 2023, with the Japan Patent Office, the disclosure of which is incorporated herein in its entirety by reference.

### TECHNICAL FIELD

The present disclosure relates to a lever-equipped connector and to a connector assembly.

### BACKGROUND

Conventionally, a connector is known which is connected to a mating connector by rotating a lever as disclosed in Japanese Patent Laid-open Publication No. 2003-257546. The connector of this type includes a detecting member displaceable to a detection position only when the lever reaches a connection position to confirm whether or not the lever has been operated to the connection position. The detecting member stays at a standby position when the lever is in an incomplete connection state, and can be pushed when the lever reaches the connection position, thereby notifying a worker that the lever is at the connection position.

### SUMMARY

The detecting member integrally includes a displacing portion to be pushed with a finger and leg portions extending from both ends of the displacing portion. With this shape, if the detecting member is pushed from above when the lever is in the incomplete connection state, the tips of the leg portions contact predetermined locations of a mating side, whereby the detecting member is held at the standby position. However, if the detecting member is pushed with an excessive force, forces are applied to the leg portions in opening directions. Thus, there has been a possibility that the detecting member is forcibly displaced in the opening directions. Therefore, there has been a concern that the worker erroneously recognizes that the connection position has been reached although the lever is in the incomplete connection state.

The present disclosure aims to provide a lever-equipped connector and a corresponding connector assembly in which a detecting member is hardly displaced from a standby position when a lever is at a pre-connection position.

This object is solved according to the invention by the features of the independent claims. Particular embodiments of the invention are subject of the dependent claims.

According to one aspect, there is provided a lever-equipped connector solving the above problem which is to be connected to a mating connector such that at least one terminal provided in a connector housing is substantially completely connected to at least one terminal of the mating connector if a lever displaceable (particularly rotatably or pivotably) provided on the connector housing to be connected to the mating connector is displaced (particularly rotated or pivoted) from a pre-connection position to a connection position, the lever including at least one detecting member attached to the lever to allow a movement from a standby position to a detection position only when the lever substantially is located at the connection position, the detecting member including a head portion arranged to be at least partly exposed from the lever for operation of the detecting member and at least one leg portion formed to extend from the head portion to be at least partly inserted into an insertion recess of the connector housing when the lever is located at the connection position, and at least one deformation suppressing portion for suppressing deformation of the leg portion in an opening direction when the detecting member is operated (particularly pushed substantially from above) with the lever located at the pre-connection position being provided between the connector housing and the leg portion.

First, particular embodiments of the present disclosure are listed and described.

The lever-equipped connector of the present disclosure is to be connected to a mating connector such that a terminal provided in a connector housing is completely connected to a terminal of the mating connector if a lever rotatably or pivotably provided on the connector housing to be connected to the mating connector is rotated or pivoted from a pre-connection position to a connection position, the lever including a detecting member attached to the lever to allow a movement from a standby position to a detection position only when the lever is located at the connection position, the detecting member including a head portion arranged to be exposed from the lever for operation of the detecting member and a leg portion formed to extend from the head portion to be inserted into an insertion recess of the connector housing when the lever is located at the connection position, and a deformation suppressing portion for suppressing deformation of the leg portion in an opening direction when the detecting member is pushed from above with the lever located at the pre-connection position being provided between the connector housing and the leg portion.

Accordingly, since the deformation suppressing portion for suppressing the deformation of the leg portion in the opening direction is provided between the connector housing and the leg portion, the leg portion is kept in position by the deformation suppressing portion even if the detecting member at the standby position is pushed from above with the lever located at the pre-connection position. Therefore, even if the detecting member at the standby position is pushed from above with the lever located at the pre-connection position, it can be made difficult for the detecting member to move from the standby position.

Particularly, the lever-equipped connector comprises at least one guiding portion for substantially guiding a movement of the detecting member by at least one contact surface of the leg portion substantially sliding on at least one corresponding guiding surface provided on the connector housing when the lever is displaced.

Further particularly, the deformation suppressing portion has the contact surface substantially formed into an inclined surface inclined downward in the opening direction and the guiding surface substantially in the form of an inclined surface formed to be substantially in surface contact with the contact surface.

Further particularly, a guiding portion is provided which guides a movement of the detecting member by a contact surface of the leg portion sliding on a guiding surface provided on the connector housing when the lever is rotated, and the deformation suppressing portion has the contact surface formed into an inclined surface inclined downward in the opening direction and the guiding surface in the form of an inclined surface formed to be in surface contact with the contact surface.

Accordingly, since the contact surface and the guiding surface are in the form of inclined surfaces, the deformation suppressing portion can be provided in a small space. Consequently, the lever-equipped connector can be reduced in size even if the deformation suppressing portion is provided.

Further particularly, a rotation axis of the lever and a movement axis of the detecting member are arranged to deviate from each other, and the guiding portion is configured to guide the lever to the connection position together with the detecting member based on an operation force from above when the detecting member is pushed from above with the lever located at the pre-connection position.

Further particularly, a guiding portion is provided which guides a movement of the detecting member by a contact surface of the leg portion sliding on a guiding surface provided on the connector housing when the lever is rotated, a rotation axis of the lever and a movement axis of the detecting member are arranged to deviate from each other, and the guiding portion is configured to guide the lever to the connection position together with the detecting member based on an operation force from above when the detecting member is pushed from above with the lever located at the pre-connection position.

Accordingly, if the detecting member is pushed from above with the lever located at the pre-connection position, the lever can be displaced (particularly rotated or pivoted) to the connection position by the guiding portion, using a force pushing the detecting member from above. When the lever reaches the connection position, the detecting member can be directly displaced from the standby position to the detection position by the force pushing the detecting member from above. In the above way, an operation (particularly a rotating or pivoting operation) of the lever and a displacing operation of the detecting member can be performed as a series of operations. This can further contribute to improving workability when the lever-equipped connector is the mating connector.

Further particularly, the contact surface is formed to be inclined substantially along a rotation direction of the lever on a tip of the leg portion, and the guiding surface is formed in an entire region of a passage for the leg portion and/or has an arcuate shape.

Accordingly, since the guiding surface for guiding a movement of the contact surface provided on the tip of the leg portion is formed over a wide range, the rotating operation of the lever can be guided by the guiding portion regardless of at which pre-connection position the lever is located. This further contributes to improving workability when the lever-equipped connector is connected to the mating connector.

Further particularly, at least one first deformation suppressing portion as the deformation suppressing portion and at least one second deformation substantially suppressing portion for suppressing the deformation of the leg portion in the opening direction in response to an operation of returning the lever from the connection position to an initial position when the detecting member is located at the detection position are provided between the connector housing and the leg portion.

Accordingly, even if the lever is rotated in a non-connection direction from the connection position with the detecting member located at the detection position, the leg portion is kept in position by the second deformation suppressing portion. Therefore, even if the lever is rotated in the non-connection direction from the connection position with the detecting member located at the detection position, it can be made difficult for the detecting member to be displaced from the detection position.

Further particularly, the lever includes at least one covering portion for at least partly covering the deformation suppressing portion from outside.

Accordingly, since the deformation of the leg portion in the opening direction can be suppressed by the covering portion of the lever, it can be made more difficult for the detecting member to be displaced from the standby position.

Further particularly, wherein the lever includes at least one supporting portion for supporting the head portion of the detecting member when being pushed.

Further particularly, the detecting member is located at a standby position before being displaced by having a movement limited by one or more guide walls when the lever is at the pre-connection position; and/or wherein the detecting member is or can be translated to a detection position by a pushing operation since one or more guide walls is/are not present when the lever is at the connection position.

According to a further aspect, there is provided a connector assembly comprising a lever-equipped connector according to the above aspect or a particular embodiment thereof and a mating connector connectable with each other by means of the lever.

The present disclosure can make it difficult for a detecting member to be displaced from a standby position when a lever is at a pre-connection position.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a lever-equipped connector according to a first specific embodiment.

FIG. 2 is a side view of the lever-equipped connector when a lever is at a pre-connection position.

FIG. 3 is a side view of the lever-equipped connector when the lever is at a connection position.

FIG. 4 is a perspective view of the lever-equipped connector showing a movement of a detecting member.

FIG. 5 is a perspective view of the detecting member.

FIG. 6 is a section along VI-VI shown in FIG. 8.

FIG. 7A is a side view of the lever-equipped connector when the detecting member is at a standby position and FIG. 7B is a side view of the lever-equipped connector when the detecting member is at a detection position.

FIG. 8 is a section of the lever-equipped connector when the lever is at the pre-connection position.

FIGS. 9A, 9B and 9C are diagrams showing a procedure of pushing the detecting member at the standby position to the detection position by displacing (particularly rotating or pivoting) the lever from the pre-connection position to the connection position while pushing the detecting member.

FIG. 10 is a perspective view of a detecting member according to a second specific embodiment.

FIG. 11 is a partial section of the lever-equipped connector showing the configuration of a second deformation suppressing portion.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Details of Embodiments of Present Disclosure

### First Embodiment

### (Lever-Equipped Connector 1)

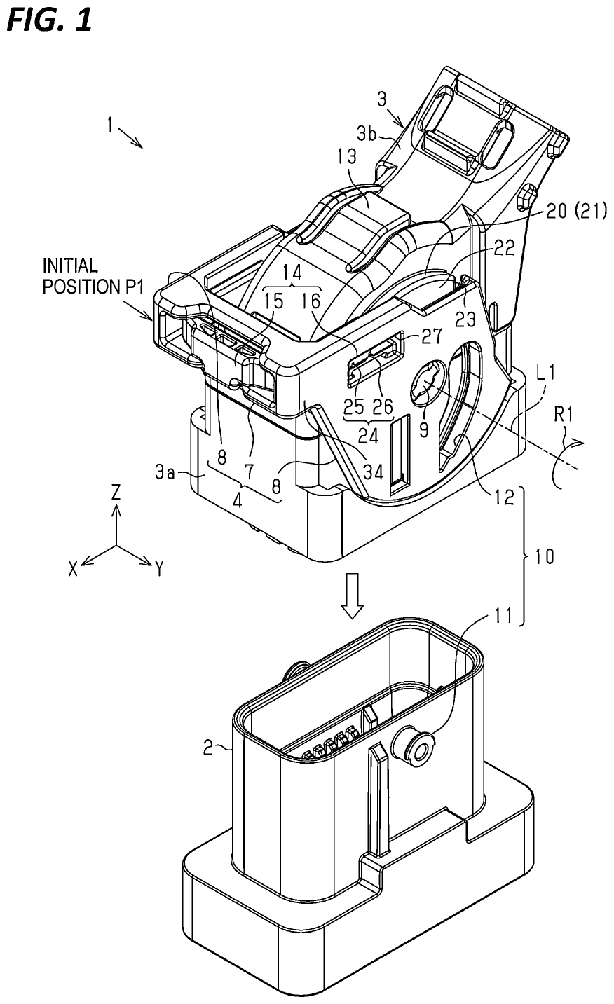

As shown in FIG. 1, a lever-equipped connector 1 is provided with a connector housing 3 to be connected to a mating connector 2 and a lever 4 displaceable (particularly rotatably or pivotably) mounted on the connector housing 3.

The connector housing 3 includes a housing body 3a and particularly a cover 3b to be mounted and/or fixed to (particularly an upper part of) the housing body 3a.

When the connector housing 3 is connected to the mating connector 2, one or more, particularly a plurality of terminals (not shown) at least partly provided inside the connector housing 3 are electrically connected or connectable to one or more, particularly a plurality of respective terminals (not shown) of the mating connector 2.

When the lever-equipped connector 1 is connected to the mating connector 2, the lever 4 is displaced or moved (particularly rotated or pivoted) in a connection direction (direction of an arrow R1 of FIG. 1) from an initial position P1 (state of FIG. 1), whereby the terminal(s) in the mating connector 2 and the connector housing 3 are completely connected.

One of the lever-equipped connector 1 and the mating connector 2 is a male connector and the other is a female connector.

### (Lever 4)

As shown in FIG. 1, the lever 4 includes a lever base portion 7 particularly arranged substantially entirely in a width direction (Y-axis direction of FIG. 1) of the connector housing 3 and one or more, particularly a pair of arm portions 8 extending from or near one or both sides of the lever base portion 7.

The arm portions 8 particularly are rotatably or pivotably mounted on one or more shaft portions 9 provided on one or both side surfaces of the connector housing 3. The lever 4 particularly rotates or pivots about the shaft portion(s) 9.

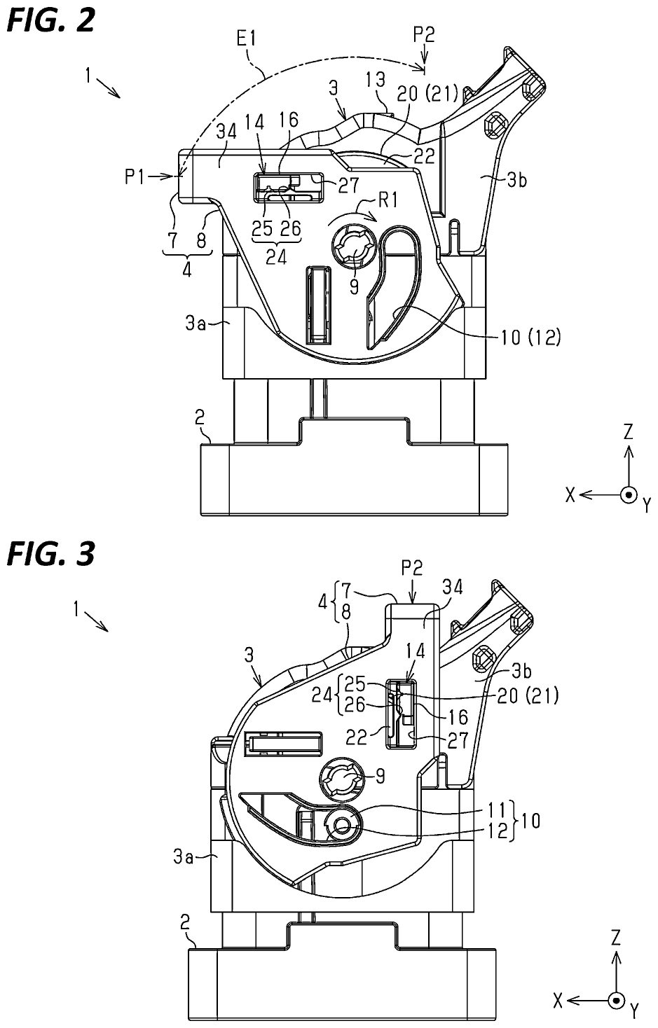

As shown in FIGS. 2 and 3, a cam mechanism 10 for generating a load or force for connecting (or at least assisting connection of) the lever-equipped connector 1 to the mating connector 2 during the displacement (particularly rotation or pivotal movement) of the lever 4 particularly is provided between the mating connector 2 and the lever 4.

The cam mechanism 10 includes, for example, one or more cam pins 11 (see FIG. 3) formed on the side surface(s) of the mating connector 2 and one or more cam holes 12 formed in the arm portion(s) 8. The cam hole 12 is, for example, formed into a curved shape.

The cam mechanism 10 particularly completely connects the lever-equipped connector 1 to the mating connector 2 by pushing or urging the peripheral surfaces of the cam holes 12 (e.g. substantially downward) by the cam pins 11 when the lever 4 is displaced (particularly rotated or pivoted) in the connection direction (direction of the arrow R1 of FIG. 1).

The lever-equipped connector 1 is connected to the mating connector 2 to completely connect the terminals of the lever-equipped connector 1 and the mating connector 2 when the lever 4 is displaced (particularly rotated or pivoted) from a pre-connection position (region E1 shown in FIG. 2) to a connection position (“P2” shown in FIGS. 2 and 3).

The pre-connection position particularly means, for example, a range from the initial position P1 to a position just before the connection position P2, out of a displacement (particularly rotation or pivotal movement) range of the lever 4.

When the lever 4 is located at the connection position P2, the lever 4 particularly is held at the connection position P2 by at least one lock piece 13 (see FIG. 2) provided on (particularly formed in the upper wall of) the connector housing 3.

### (Detecting Member 14)

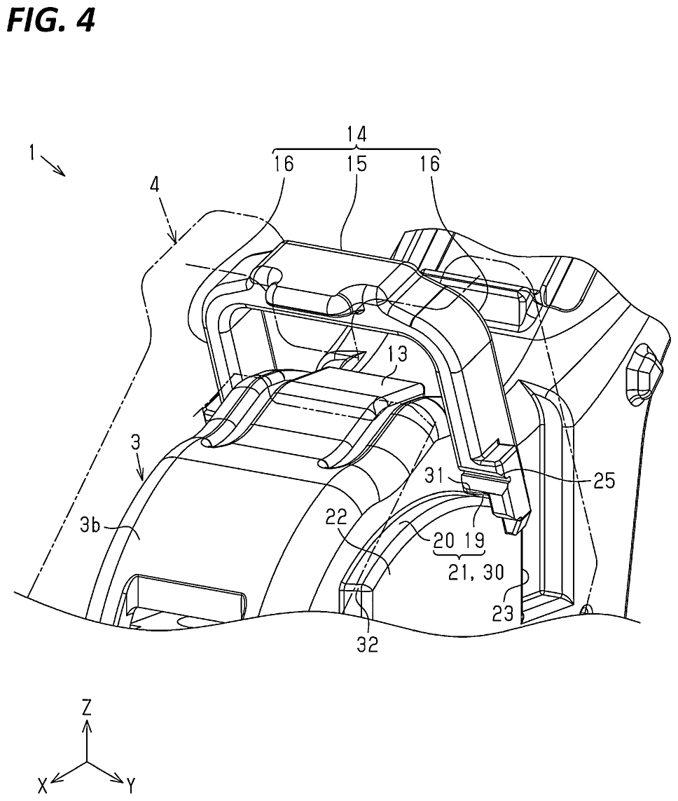

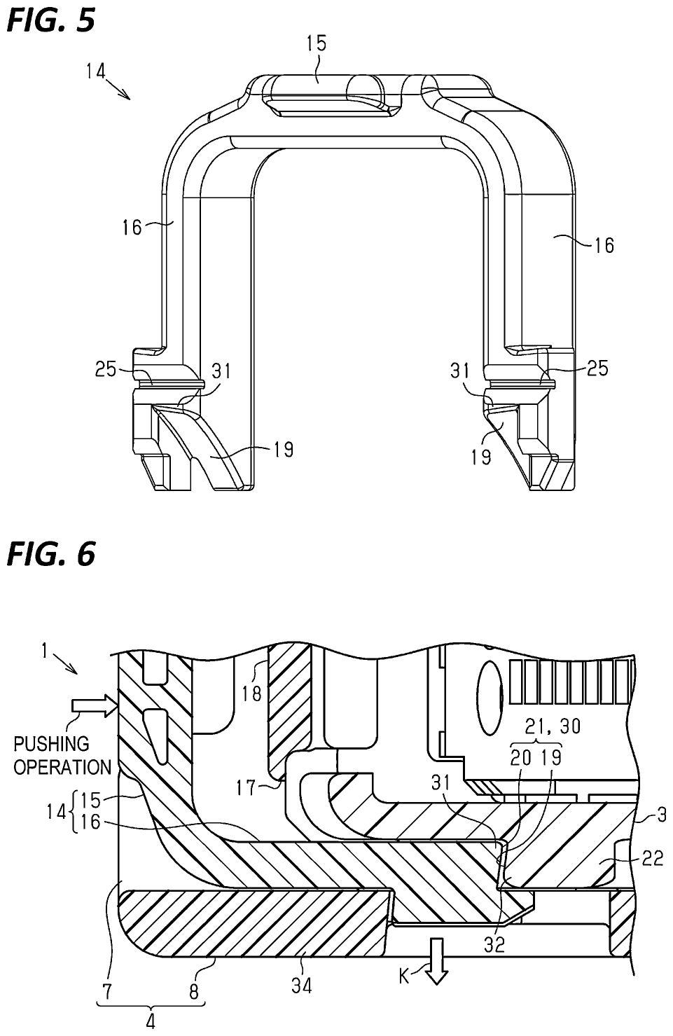

As shown in FIGS. 4 and 5, the lever-equipped connector 1 particularly is provided with at least one detecting member 14 for detecting whether or not the lever 4 is located at the connection position P2.

The detecting member 14 specifically includes a head portion 15 and one or more leg portions 16.

The head portion 15 particularly is arranged to be exposed from the lever 4 for the operation of the detecting member 14. That is, the head portion 15 can be operated with a finger or the like from outside e.g. by a worker.

The one or more leg portions 16 are formed to extend from the head portion 15. A pair of the leg portions 16 particularly are formed on both sides of the head portion 15 in this example.

As shown in FIG. 6, the lever 4 particularly is formed with one or more, particularly a pair of openings 17 (only one is shown in FIG. 6) for at least partly inserting the leg portions 16.

The lever 4 particularly is formed with at least one supporting portion 18 for supporting the head portion 15 of the detecting member 14 when being pushed.

As shown in FIG. 4, the lever-equipped connector 1 is provided with one or more guiding portions 21 for guiding a movement of the detecting member 14 by one or more contact surfaces 19 of the leg portion(s) 16 sliding on one or more guiding surfaces 20 provided on the connector housing 3.

The guiding portions 21 particularly function as guides for substantially guiding a movement of the detecting member 14 when the lever 4 is displaced (particularly rotated or pivoted).

Specifically, the one or more guiding surfaces 20 are formed on the upper surface(s) of guide wall(s) 22 formed on side wall surface(s) of the connector housing 3 (specifically the cover 3b in this example).

At least one insertion recess 23 for at least partly inserting the leg portion 16 particularly is provided at or near a movement end of the leg portion 16 in the guiding surface 20.

One or more, particularly a pair of the insertion recesses 23 are provided in the width direction (Y-axis direction of FIG. 4) to substantially correspond to the one or more, particularly two leg portions 16 of the detecting member 14.

The insertion recess 23 particularly is formed by recessing the side wall of the connector housing 3.

The leg portion 16 particularly is at least partly insertable into the insertion recess 23 of the connector housing 3 when the lever 4 is located at the connection position P2.

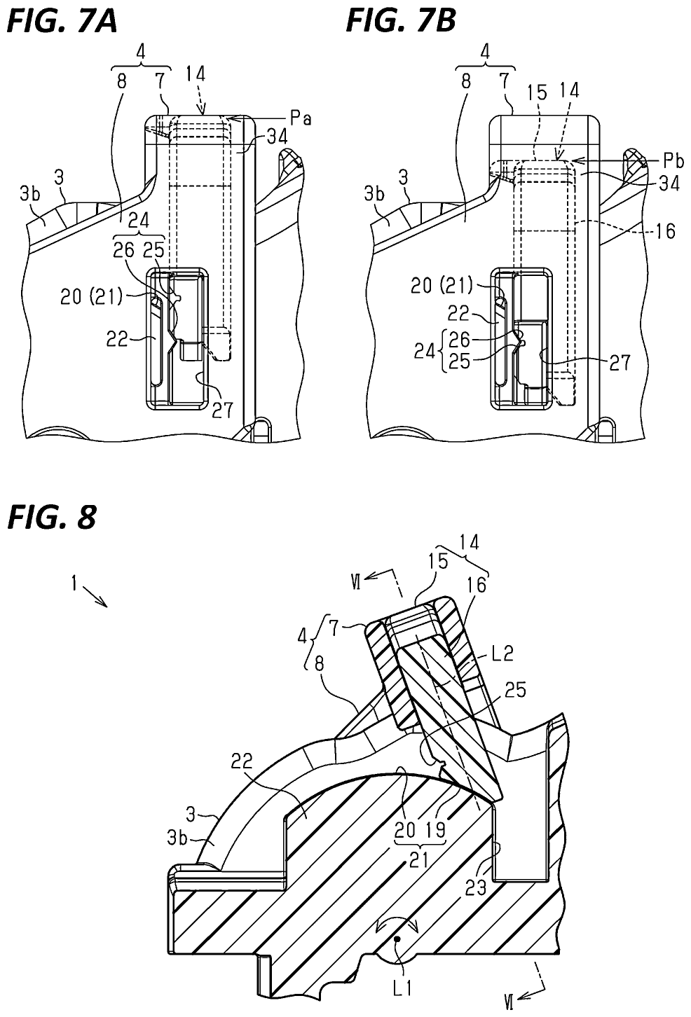

As shown in FIG. 7A, the detecting member 14 particularly is located at a standby position Pa before being displaced (e.g. pushed).

Further, the detecting member 14 particularly is located at the standby position Pa by having a (e.g. substantially downward) movement limited by the guide wall(s) 22 when the lever 4 is at the pre-connection position.

On the other hand, as shown in FIG. 7B, the detecting member 14 particularly is or can be switched or translated to a detection position Pb by a pushing operation since the guide wall(s) 22 is/are not present when the lever 4 is at the connection position P2.

In this way, the detecting member 14 is so attached or mounted to the lever 4 to allow a movement from the standby position P1 to the detection position Pb only when the lever 4 is located at the connection position P2.

As shown in FIGS. 7A and 7B, the detecting member 14 particularly includes one or more lock portions 24 for holding a state where the detecting member 14 is at the detection position Pb.

The lock portion 24 particularly includes a lock groove 25 in a wall surface of the leg portion 16.

The lock portion 24 particularly is locked by engaging a corresponding projection 26 formed on the lever 4 with the lock groove 25 when the detecting member 14 is operated to the detection position Pb.

Note that at least one window portion 27 particularly is formed to be open in the arm portion 8 of the lever 4 by forming the projection 26 on the lever 4 by a slide mold.

### (Deformation Suppressing Portion 30)

As shown in FIGS. 4 and 6, at least one deformation suppressing portion 30 for suppressing the deformation of the leg portion 16 in an opening direction (direction of an arrow K of FIG. 6) when the detecting member 14 is operated (e.g. pushed) particularly from above with the lever 4 located at the pre-connection position particularly is provided between the connector housing 3 and the leg portion 16.

In the case of this example, the deformation suppressing portion 30 particularly is configured as the guiding portion 21. That is, the deformation suppressing portion 30 particularly includes the contact surface 19 formed into an inclined surface inclined (e.g. substantially downward) in the opening direction and/or the guiding surface 20 formed to come substantially into surface contact with the contact surface 19.

The contact surface 19 of this example particularly substantially is formed into an inclined surface formed on the tip surface of the leg portion 16 and/or inclined downward in the opening direction.

In the case of this example, the contact surface 19 particularly substantially is formed into an inclined surface by providing an inclined protrusion 31 on the surface.

The guiding surface 20 of this example is formed into an inclined surface substantially inclined downward in a direction opposite to that of the contact surface 19.

In the case of this example, the guiding surface 20 is formed into an inclined surface particularly by providing at least one inclined protrusion 32 on the surface.

As just described, the deformation suppressing portion 30 suppresses the deformation of the leg portion 16 in the opening direction by the inclined protrusions 31, 32 engaged with each other.

### (Covering Portion 34)

As shown in FIG. 6, the lever 4 particularly includes one or more covering portions 34 for at least partly covering the deformation suppressing portions 30 from outside.

In the case of this example, the covering portion 34 particularly is constituted by a part of the arm portion 8. That is, the covering portion 34 particularly is constituted by a part covering the leg portion 16 in the arm portion 8 constituting the side wall of the lever 4.

The covering portion 34 suppresses the opening deformation of the leg portion 16 particularly by supporting the leg portion 16 from outside when a load is applied to the leg portion 16 in the opening direction.

(Displacement e.g. Rotating Operation of Lever 4 Using Pushing Operation of Detecting Member 14)

As shown in FIG. 8, a displacement direction or a rotation axis L1 of the lever 4 and a movement axis L2 of the detecting member 14 are arranged to deviate from each other. Note that, in the case of this example, “arranged to deviate from each other” means that the movement axis L2 does not intersect the displacement direction or rotation axis L1.

The movement axis L2 particularly is a line extending in a longitudinal direction of the detecting member 14 and, in the case of this example, a straight line.

The detecting member 14 particularly moves along the movement axis L2 between the standby position Pa and the detection position Pb.

The guiding portion 21 particularly is configured to substantially guide the lever 4 to the connection position P2 together with the detecting member 14 based on an operation force (e.g. from above) when the detecting member 14 is operated (e.g. pushed from above) with the lever 4 located at the pre-connection position.

The contact surface 19 of this example substantially is formed into an inclined surface along a displacement (e.g. rotation) direction of the lever 4 on (particularly the tip of) the leg portion 16.

Specifically, the contact surface 19 substantially is formed into an arcuate shape in a side view of the leg portion 16 for the case of a rotatably or pivotably displaceable lever 4.

The guiding surface 20 of this example is formed in the entire region of a passage for the leg portion 16.

In particular, the guiding surface 20 particularly substantially has an arcuate shape. Specifically, the guiding surface 20 substantially is formed into an arcuate shape to be in surface contact with the contact surface 19.

Next, functions of the lever-equipped connector 1 of this embodiment are described.

### (Functions of Deformation Suppressing Portions 30)

As shown in FIG. 6, the detecting member 14 may be erroneously operated (e.g. pushed) although the lever 4 is located not at the connection position P2, but at the pre-connection position (region E1).

In the case of this example, since the one or more deformation suppressing portions 30 particularly are provided between the connector housing 3 and the detecting member 14, even if the detecting member 14 is operated (e.g. pushed from above), a load applied to the detecting member 14 escapes inward by the engagement of the inclined protrusions 31, 32.

Thus, forces are hardly applied to the leg portion(s) 16 of the detecting member 14 in the opening direction(s).

Therefore, it can be made difficult for the detecting member 14 to be accidentally detached from the connector housing 3.

### (Series of Operations of Lever 4 and Detecting Member 14)

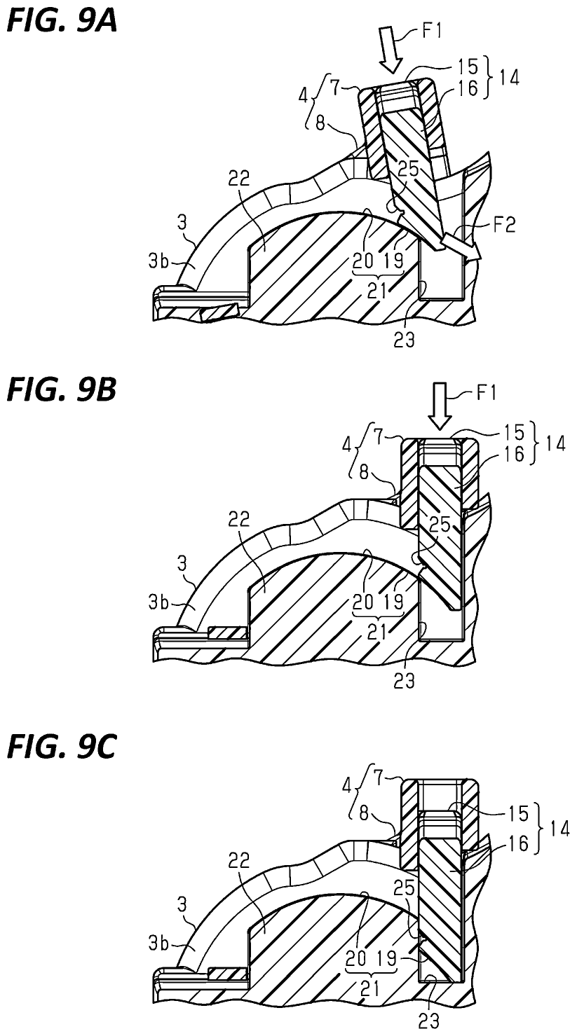

It is assumed that the detecting member 14 is operated (e.g. pushed from above) when the lever 4 is at the pre-connection position (region E1) as shown in FIG. 9A.

At this time, an operation force “F1 (white arrow in FIG. 9A)” from above particularly is converted into a load “F2” substantially for moving the detecting member 14 along the guiding surface(s) 20 particularly by the shape of the guiding portion(s) 21, i.e. the inclined contact surface(s) 19 and the arcuate guiding surface(s) 20 substantially in surface contact with the contact surfaces 19.

This particularly is because the rotation axis L1 of the lever 4 and the movement axis L2 of the detecting member 14 particularly are arranged to deviate from each other and the contact surfaces 19 and the guiding surfaces 20 are formed to be inclined.

Thus, if the detecting member 14 particularly is operated (e.g. pushed from above) when the lever 4 is at the pre-connection position (region E1), the lever 4 can be displaced (particularly rotated or pivoted) to the connection position P2 by that force in a pushing direction (state of FIG. 9B).

If the lever 4 reaches the connection position P2 as shown in FIGS. 9B and 9C, the detecting member 14 can be directly operated (e.g. pushed) to the detection position Pb particularly with a finger having operated the lever 4 to the connection position P2.

That is, it particularly is possible to displace (particularly rotate or pivot) the lever 4 and push the detecting member 14 by a series of operations to push the detecting member 14 from above after the lever 4 is moved from the pre-connection position to the connection position P2 particularly without leaving the finger from the detecting member 14.

As described above, in the case of this example, the displacement (particularly rotation or pivotal movement) of the lever 4 to the connection position P2 and the pushing of the detecting member 14 to the detection position Pb can be successively performed by pushing the detecting member 14 of the lever 4 at the pre-connection position from above when the lever 4 is at the pre-connection position.

Thus, an operation of displacing (particularly rotating or pivoting) the lever 4 to the connection position P2 and an operation of pushing the detecting member 14 need not be separately performed.

Therefore, assemblability in assembling the lever-equipped connector 1 with the mating connector 2 can also be improved.

According to the configuration of the above embodiment, the following effects can be obtained.

(1-1) The lever-equipped connector 1 particularly is connected to the mating connector 2 such that the one or more terminals provided in the connector housing 3 and the one or more respective terminals of the mating connector 2 are completely connected if the lever 4 displaceable (particularly rotatably or pivotably) provided on the connector housing 3 to be connected to the mating connector 2 is displaced (particularly rotated or pivoted) from the pre-connection position to the connection position P2.

The lever-equipped connector 1 particularly is provided with the at least one detecting member 14 attached to the lever 4 to allow a movement from the standby position P to the detection position Pb only when the lever 4 is located at the connection position P2.

The detecting member 14 particularly includes the head portion 15 arranged to be at least partly exposed from the lever 4 for the operation of the lever 4 and the one or more leg portions 16 formed to extend from the head portion 15 particularly to be at least partly inserted into the insertion recesses 23 of the connector housing 3 when the lever 4 is located at the connection position P2.

The one or more deformation suppressing portions 30 for suppressing the deformation of the leg portion(s) 16 in the opening direction(s) when the detecting member 14 is operated (e.g. pushed from above) with the lever 4 located at the pre-connection position are provided between the connector housing 3 and the leg portions 16.

According to this particular configuration, since the one or more deformation suppressing portions 30 for suppressing the deformation of the one or more leg portions 16 in the opening direction(s) are provided between the connector housing 3 and the leg portion(s) 16, the leg portions 16 particularly are kept in position by the deformation suppressing portion(s) 30 even if the detecting member 14 at the standby position Pa is pushed from above with the lever 4 located at the pre-connection position.

Thus, it can be made difficult for the detecting member 14 to move from the standby position Pa even if the detecting member 14 at the standby position Pa is pushed from above with the lever 4 located at the pre-connection position.

(1-2) The lever-equipped connector 1 particularly is provided with the one or more guiding portions 21 for substantially guiding a movement of the detecting member 14 by the one or more contact surfaces 19 of the one or more leg portions 16 substantially sliding on the one or more guiding portions 20 provided on the connector housing 3 when the lever 4 is displaced (particularly rotated or pivoted).

The deformation suppressing portion 30 particularly includes the contact surface 19 substantially formed into the inclined surface inclined downward in the opening direction and/or the guiding surface 20 substantially in the form of the inclined surface formed to be in surface contact with the contact surface 19.

According to this configuration, since the contact surface 19 and/or the guiding surface 20 particularly substantially are in the form of the inclined surfaces, the deformation suppressing portion 30 can be provided in a small space.

Consequently, the lever-equipped connector 1 can be reduced in size even if the one or more deformation suppressing portions 30 are provided.

(1-3) Specifically, the rotation axis L1 of the lever 4 and the movement axis L2 of the detecting member 14 particularly are arranged to deviate from each other.

The guiding portions 21 particularly are configured to substantially guide the lever 4 to the connection position P2 together with the detecting member 14 based on an operation force (e.g. substantially from above) when the detecting member 14 is operated (e.g. pushed from above) with the lever 4 located at the pre-connection position.

According to this configuration, if the detecting member 14 is pushed e.g. from above with the lever 4 located at the pre-connection position, the lever 4 can be displaced (particularly rotated or pivoted) to the connection position P2 by the guiding portions 21, using a force pushing the detecting member 14 from above.

When the lever 4 particularly reaches the connection position P2, the detecting member 14 particularly can be directly displaced from the standby position Pa to the detection position Pb by the force pushing the detecting member 14 from above.

In the above way, the displacing (particularly rotating or pivoting) operation of the lever 4 and the displacing operation of the detecting member 14 particularly can be performed as a series of operations.

Therefore, workability when the lever-equipped connector 1 is connected to the mating connector 2 can be improved.

(1-4) The contact surface 19 particularly is formed to be inclined substantially along the displacement direction (particularly the rotation or pivoting direction) of the lever 4 on (particularly the tip of) the leg portion 16.

The guiding surface 20 particularly is formed substantially in the entire region of the passage for the leg portion 16 and/or particularly substantially has an arcuate shape.

According to this configuration, since the guiding surface 20 for guiding a movement of the contact surface 19 provided on (particularly the tip of) the leg portion 16 is formed over a wide range, the displacement operation (particularly the rotating or pivoting operation) of the lever 4 can be guided by the guiding portions 21 regardless of at which pre-connection position the lever 4 is located.

This (particularly further) contributes to improving workability when the lever-equipped connector 1 is connected to the mating connector 2.

(1-5) The lever 4 particularly includes the one or more covering portions 34 for at least partly covering the deformation suppressing portions 30 substantially from outside.

According to this configuration, since the deformation of the leg portions 16 in the opening directions particularly can be suppressed also by the covering portions 34 of the lever 4, it can be made more difficult for the detecting member 14 to be displaced from the standby position Pa.

Accordingly, there is disclosed a lever-equipped connector in which a detecting member is hardly displaced from a standby position when a lever is at a pre-connection position, wherein the lever-equipped connector 1 is provided with a detecting member 14 attached to a lever 4 to allow a movement from a standby position to a detection position only when the lever 4 is located at a connection position. The detecting member 14 includes a head portion 15 arranged to be exposed from the lever 4 for operation of the detecting member 14 and a leg portion 16 formed to extend from the head portion 15 to be inserted into an insertion recess 23 of a connector housing 3 when the lever 4 is located at the connection position. A deformation suppressing portion 30 for suppressing deformation of the leg portion 16 in an opening direction when the detecting member 14 is pushed from above with the lever 4 located at the pre-connection position is provided between the connector housing 3 and the leg portion 16.

### Second Embodiment

Next, a second specific embodiment is described. Note that, in the second embodiment, means for preventing the opening of the leg portion(s) 16 of the detecting member 14 described in the first embodiment particularly is (also) provided in another location.

Thus, the similar or same components as those of the first embodiment are denoted by the same reference signs and not described, and only substantially different components are described in detail.

### (First Deformation Suppressing Portion 41)

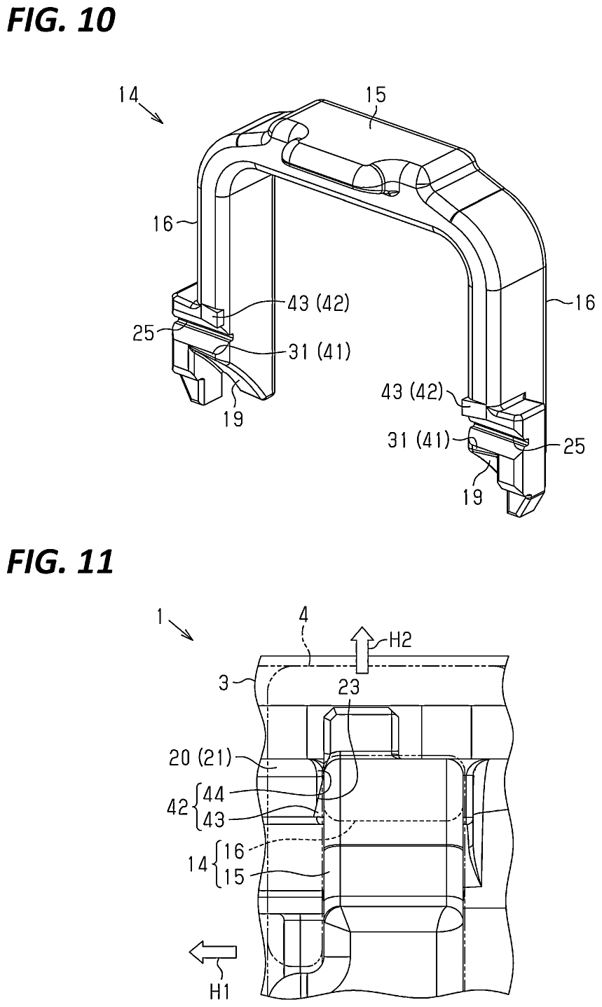

As shown in FIG. 10, one or more first deformation suppressing portions 41 as the deformation suppressing portion(s) 30 described in the first embodiment are provided between a connector housing 3 and leg portions 16.

As described above, the first deformation suppressing portions 41 particularly are provided to substantially suppress the deformation of the leg portion(s) in opening direction(s) when a detecting member 14 is operated (e.g. pushed from above) with a lever 4 located at a pre-connection position.

Note that, since having a configuration similar to that of the deformation suppressing portion 30 of the first embodiment, the first deformation suppressing portion 41 is not described.

### (Second Deformation Suppressing Portions 42)

As shown in FIGS. 10 and 11, one or more second deformation suppressing portions 42 for suppressing the deformation of the leg portion(s) 16 in the opening direction(s) in response to an operation of returning the lever 4 from a connection position P2 to an initial position P1 when the detecting member 14 is at a detection position Pb particularly are provided between the connector housing 3 and the leg portion(s) 16.
The second deformation suppressing portion 42 of this example particularly includes at least one inclined protrusion 43 provided on the leg portion 16 and/or at least one inclined protrusion 44 provided on the connector housing 3.

The inclined protrusion 43 of the leg portion 16 particularly is formed on a side surface of (particularly the tip of) the leg portion 16, i.e. a part to be at least partly inserted into an insertion recess 23.

The inclined protrusion 43 is, for example, formed to be substantially inclined downward from inside toward outside.

The inclined protrusion 44 of the connector housing 3 particularly is formed on the inner wall of the insertion recess 23 of the connector housing 3, i.e. substantially at a position facing the inclined protrusion 43 in the insertion recess 23.

The inclined protrusion 44 is, for example, formed to be substantially inclined downward from outside toward inside.

### Functions of Embodiment

It is assumed that the lever 4 at the connection position P2 is displaced (particularly rotated or pivoted) in a direction toward the pre-connection position (direction of an arrow H1 shown in FIG. 11) when the detecting member 14 is at the detection position Pb as shown in FIG. 11.
At this time, since the leg portion 16 particularly is strongly butted against the wall surface of the insertion recess 23, a force is applied to the leg portion 16 in the opening direction (direction of an arrow H2 of FIG. 11). If this force in the opening direction is large, the leg portion 16 particularly is deformed. Thus, the detecting member 14 is possibly detached from the insertion recess 23.
Therefore, the lever 4 is or can be displaced (particularly rotated or pivoted) towards or to the pre-connection position although the detecting member 4 is at the detection position Pb.

However, in the case of this specific example, since the one or more second deformation suppressing portions 42 particularly are provided between the connector housing 3 and the detecting member 14, even if an opening load is applied to the detecting member 14 in the direction of the arrow H2, the load applied to the detecting member 14 escapes inward by the engagement of the inclined protrusions 43, 44.

Thus, forces in the opening directions are hardly applied to the leg portions 16 of the detecting member 14.

Therefore, it can be made difficult for the detecting member 14 to be accidentally detached from the connector housing 3.

### Effects of Embodiment

According to the configuration of the above embodiment, the following effects can be obtained in addition to the effects described in the first embodiment.

The one or more first deformation suppressing portions 41 as the deformation suppressing portions 30 particularly are provided between the connector housing 3 and the leg portion(s) 16.

The one or more second deformation suppressing portions 42 for suppressing the deformation of the leg portion(s) 16 in the opening directions in response to the operation of returning the lever 4 from the connection position P2 to the initial position when the detecting member 14 is located at the detection position Pb particularly are provided between the connector housing 3 and the leg portions 16.

According to this configuration, even if the lever 4 is displaced (particularly rotated or pivoted) in the non-connection direction from the connection position P2 with the detecting member 14 located at the detection position Pb, the leg portions 16 are kept in position by the second deformation suppressing portions 42.

Thus, even if the lever 4 is displaced (particularly rotated or pivoted) in the non-connection direction from the connection position P2 with the detecting member 14 located at the detection position Pb, it can be made difficult for the detecting member 14 to be displaced from the detection position Pb.

### Other Embodiments

Note that the above embodiments can be modified and carried out as follows. The above embodiments and the following modifications can be carried out in combination without technically contradicting each other.
   In each embodiment, the lever 4 may be displaced between the initial position P1 and the connection position P2 in a substantially linear way, i.e. following a substantially linear (not-rotating or non-pivoting) movement.
   In each embodiment, the lever 4 may be upright at the initial position P1 and may be tilted at the connection position P2.
   In each embodiment, the connection direction of the lever-equipped connector 1 and the mating connector 2 is not limited to a height direction (Z-axis direction of each figure) of the connector housing 3 and may be, for example, a depth direction (X-axis direction of each figure) of the connector housing 3.
   In each embodiment, there is no limitation to the pair of leg portions 16 of the detecting member 14, and only one leg portion 16 may be provided. Further, three or more leg portions 16 may be provided.
   In each embodiment, the deformation suppressing portion 30 is not limited to a structure for bringing the facing inclined surfaces into contact with each other. The deformation suppressing portion 30 may be, for example, structured such that a protrusion provided on one of the connector housing 3 and the detecting member 14 is engaged with a groove provided in the other of these.
In each embodiment, the deformation suppressing portion 30 may be provided in a location different from the guiding portion 21. That is, the deformation suppressing portion 30 may be provided anywhere between the connector housing 3 and the detecting member 14.
   In each embodiment, the shape of the contact surface 19 is not limited to the substantially arcuate shape, but may be, for example, a linear inclined surface shape.
   In each embodiment, the guiding portion 21 is not limited to the one formed in the substantially entire region on the movement passage of the detecting member 14 when the lever 4 is displaced (particularly rotated or pivoted) from the pre-connection position to the connection position P2, but may be formed in a part of the movement passage, preferably only at an end part of the movement passage.
   In each embodiment, the guiding surface 20 is not limited to the one formed in the substantially entire region of the passage for the leg portion 16, but may be formed only in a part of the passage.
   In each embodiment, the shape of the detecting member 14 can be appropriately changed to a shape other than the one described in the embodiments.
   In each embodiment, the lock portion 24 is not limited to the one provided on the tip of the leg portion 16, but may be, for example, formed on the base end of the leg portion 16 or the head portion 15.
   In each embodiment, the lock groove 25 of the lock portion 24 may be engaged with the connector housing 3 when the detecting member 14 is located at the detection position Pb.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lever-equipped connector to be connected to a mating connector such that at least one terminal provided in a connector housing is substantially completely connected to at least one corresponding terminal of the mating connector if a lever displaceably provided on the connector housing to be connected to the mating connector is displaced from a pre-connection position to a connection position,
the lever including at least one detecting member attached to the lever to allow a movement from a standby position to a detection position only when the lever substantially is located at the connection position,
the detecting member including a head portion arranged to be at least partly exposed from the lever for operation of the detecting member and at least one leg portion formed to extend from the head portion to be at least partly inserted into an insertion recess of the connector housing when the lever is located at the connection position, and
at least one deformation suppressing portion for suppressing deformation of the leg portion in an opening direction when the detecting member is operated with the lever located at the pre-connection position being provided between the connector housing and the leg portion.

2. The lever-equipped connector according to claim 1, comprising at least one guiding portion for substantially guiding a movement of the detecting member by at least one contact surface of the leg portion substantially sliding on at least one corresponding guiding surface provided on the connector housing when the lever is displaced.

3. The lever-equipped connector according to claim 2, wherein the deformation suppressing portion has the contact surface substantially formed into an inclined surface inclined downward in the opening direction and the guiding surface substantially in the form of an inclined surface formed to be substantially in surface contact with the contact surface.

4. The lever-equipped connector according to claim 2, wherein a rotation axis of the lever and a movement axis of the detecting member are arranged to deviate from each other, and
the guiding portion is configured to guide the lever to the connection position together with the detecting member based on an operation force from above when the detecting member is pushed from above with the lever located at the pre-connection position.

5. The lever-equipped connector according to claim 4, wherein:
the contact surface is formed to be inclined substantially along a rotation direction of the lever on a tip of the leg portion, and/or
the guiding surface is formed in an entire region of a passage for the leg portion and/or has an arcuate shape.

6. The lever-equipped connector according to claim 1, wherein at least one first deformation suppressing portion as the deformation suppressing portion and at least one second deformation suppressing portion for substantially suppressing the deformation of the leg portion in the opening direction in response to an operation of returning the lever from the connection position to an initial position when the detecting member is located at the detection position are provided between the connector housing and the leg portion.

7. The lever-equipped connector according to claim 1, wherein the lever includes at least one covering portion for at least partly covering the deformation suppressing portion from outside.

8. The lever-equipped connector according to claim 1, wherein the lever includes at least one supporting portion for supporting the head portion of the detecting member when being pushed.

9. The lever-equipped connector according to claim 1, wherein the detecting member is located at a standby position before being displaced by having a movement limited by one or more guide walls when the lever is at the pre-connection position; and/or wherein the detecting member is or can be translated to a detection position by a pushing operation since one or more guide walls is/are not present when the lever is at the connection position.

10. A connector assembly comprising a lever-equipped connector according to claim 1 and a mating connector connectable with each other by means of the lever.
